(19) United States
(12) Patent Application Publication
(10) Pub. No.: US 2008/0282935 A1
(43) Pub. Date: Nov. 20, 2008

(54) METHOD AND COMPOSITION FOR ADDING COLOR TO CONCRETE

(76) Inventor: James Miller, Arcadia, IN (US)

Correspondence Address: INDIANO VAUGHAN LLP, ONE N. PENNSYLVANIA STREET, SUITE 1300, INDIANAPOLIS, IN, 46204, US

(21) Appl. No.: 12/120,298

(22) Filed: May 14, 2008

Related U.S. Application Data
(60) Provisional application No. 60/930,335, filed on May 15, 2007.

(51) Int. Cl. C04B 16/00

(52) U.S. Cl. 106/661

(57) ABSTRACT

A colorizing composition for adding color to a concrete structure comprises a color additive containing a pigment component, a vegetable oil based diluent, and a vegetable oil based sealer component. The combined sealer and color additive, when applied to a pervious concrete, will permit the flow of water through the pervious concrete.

### I. PRIORITY CLAIM

The instant application claims the benefit of Miller, U.S. Provisional Patent No. 60/930,335 filed 15 May 2007, which provisional application is fully incorporated herein by reference.

### II. TECHNICAL FIELD OF THE INVENTION

The present invention relates to concrete formulations, and more particularly, to a colorizing and sealing system useable with all concrete, and in particular, pervious concrete, to add a desired color to the concrete.

### III. BACKGROUND OF THE INVENTION

Currently, two primary categories of concrete exist. These categories include “pervious” and “impervious” concrete. The primary difference between pervious concrete and impervious concrete is that water and other fluids can flow through pervious concrete, where as impervious concrete serves as a barrier through which water cannot flow, or at best can flow at a very restricted rate.

Traditionally, most concrete installations in parking lots, roads, driveways, decks, and other surface features and the like have been made of impervious concrete. Impervious concrete serves its function as being a surface material for roads and parking lots quite well. It is capable of bearing great loads, is durable, and is long lasting.

In some installations, it has been desired to add color to the impervious concrete to impart it with a particular color, such as gray, white, etc. There are two basic methods used to colorize impervious concrete. One method is to add a colorant to the flowable concrete at the mixing plant by placing a colorant in the concrete as it is being mixed. This method is conceptually similar to the manner in which one might color a cake by mixing food coloring into the unbaked flowable batter during mixing. This concrete is then dyed a color so that when the concrete is applied to the ground to form the slab (e.g. parking lot, patio, etc.), the concrete will hopefully cure to the color to which it is dyed.

Another way to colorize impervious concrete is by acid staining the concrete. Acid staining usually is performed after the concrete has hardened (cured), and typically cannot be done for 21 days or so after the concrete is applied. The 21 day period is necessary because that is the period normally required to fully cure the concrete. The acid staining technique is performed by spraying a pigment-containing acid on the concrete. When the acid is sprayed on the concrete, the acid actually breaks down the mortar paste of the concrete enough to let the color penetrate into the concrete. When the pigment containing acid has penetrated into the surface of the concrete (usually after one day), any “scale” created in the acid-mortar concrete is removed by “brooming off” the scale.

The acid-treated concrete must then be neutralized. Once the acid pigment has been neutralized, the concrete should then be resealed if the desired color has been obtained. A good neutralizer is baking soda. If the desired color has not been obtained, the process can then be repeated to better achieve the desired color.

Typically, the sealers employed are conventional petroleum-based, water-based, or acrylic sealers. One sealer that can be used is THE BEAN® brand sealer that is distributed by C2 Products. THE BEAN®-brand sealer is a soybean oil-based sealer.

Another method for staining concrete is to apply a topical coating to concrete that is similar to paint. In this process, one applies a pigment to a film forming material such as any concrete sealer to form what is essentially a paint, that forms a topical coating over the concrete. For example, Behr® produces a variety of concrete stains and sealers. See, www.behr.com. One such stain is described as having a “siliconized 100% Styrene Acrylic formula” that creates a “durable, weather resistant, semi-transparent concrete stain designed to help protect and enhance both exterior and interior horizontal concrete surfaces”. See www.behr.com.

Although such topical treatments can produce stained concrete having a desired color, there are certain drawbacks. One drawback is that like any paint, these topical paint coatings wear off in time, especially when such paints are used as a covering for a surface over which traffic flows, such as a garage floor over which cars drive or basement floors over which people walk. Another difficulty with such topical treatments is that since such topical treatments form a film over the concrete, they are not very suitable for pervious concrete. These paints are not suitable for pervious concrete since the film these form blocks the “pores” in the pervious concrete, to thereby turn the pervious concrete into an impervious concrete. The film coating formed by such paints prevents water from passing through the previously pervious concrete, thus rendering the concrete functionally impervious.

Although impervious concrete performs its function well, room for improvement exists. In particular, one problem that is encountered with impervious concrete is that water, such as rain water, that impacts the impervious concrete can not pass through the concrete. Since impervious concrete is impervious to the flow of water therethrough, most of the water that contacts the concrete must be dealt with as run off.

When a land owner or building owner creates a large impervious concrete structure, such as a supermarket or super-store parking lot, run-off produced from a significant rain storm can be quite substantial due to the multi-acre size of such a concrete surfaced area. In order to comply with environmental regulations, land owners who have such large impervious areas, such as parking lots, are often forced to capture and treat the run off. Typically, a retention pond is excavated adjacent to the parking lot to capture the run-off and treat the run-off before the run-off is discharged either to a water body (e.g. river, lake or pond), or into the ground (and into the ground water) or into a storm sewer system. As will be appreciated, creating retention ponds is often expensive, as the creation of a retention pond involves both the expenditure of monies to pay for the excavation, along with paying monies to purchase the land on which the excavation pond sits.

In order to overcome these problems, many land owners, strip mall and other commercial and residential developers have turned to the use of pervious concrete as a replacement for impervious concrete.

Pervious concrete is a type of concrete that allows water and other fluids to pass therethrough at significant flow rates. As such, when rain falls upon a parking lot made from pervious concrete, there is little run-off. Rather than running off the concrete, the rainfall percolates through the pervious concrete and then enters the ground and ground water below the parking lot. During the water's percolation through the pervious concrete, many impurities in the water are trapped by the pervious concrete and underlayment since the pervious concrete and the gravel underlayment serve as filters for the water percolating there through. Because of this filtering, the water that flows out through the bottom of the pervious concrete is usually sufficiently well treated to enable the water to be introduced into the ground as ground water without requiring any further purification or treatment.

In recent years, there has been a strong push to make all construction projects more environmentally friendly. To this end, LEED Standards have been created. See, www.usgbc.org. Also, the United States Government has provided incentives for implementing such green construction techniques, such as by awarding grants to municipalities that perform environmentally friendly construction techniques, and by providing other incentives.

The LEED System works by awarding points based upon the environmental impact of a particular technique or project. For example, a construction project may be awarded a certain number of LEED points for using pervious concrete for a parking area, rather than an impervious concrete. With the aforementioned government grants, and/or incentives, the size of the incentive is often based on the number of LEED points accumulated by the project. Alternately, the incentive plan may require the project to acquire a certain number of LEED points to obtain the incentive. This ability to gain LEED “points” and to thereby garner the incentives provided thereby, by using pervious concrete has also fostered the use of pervious concrete.

The use of pervious concrete is among the Best Management Practices recommended by the EPA—and by other agencies and geo-technical engineers for the management of storm water runoff on a regional and local basis.

Unfortunately, the nature of pervious concrete makes it more difficult to color, when compared to impervious concrete.

One way that one can add color to pervious concrete is to dye the pervious concrete in a manner similar to the manner in which impervious concrete is dyed. That is, a colorant can be applied to the concrete as it is being batch mixed at the concrete plant. However, the pigment containing acid etch technique that enables one to stain impervious concrete on site does not work that well, if at all, with pervious concrete.

It is believed that pervious concrete can be acid stained using an acid to carry the pigment that colors the pervious concrete. However, using an acidic carver/etcher may be harmful to the environment. Since pervious concrete allows liquids to pass through, pervious concrete will permit the acidic dye to flow through the concrete and thereby possibly contaminate the soil under the pervious concrete slab, thus potentially causing environmental harm.

The neutralization step presents another difficulty to the use of an acid stain to color pervious concrete. In order to neutralize the pigment containing acid, one pours a neutralizer, such as baking soda, on the concrete slab, and then works the neutralizer into the concrete slab with a brush. One then pours water on the baking soda containing slab to neutralize the acid.

Because of the porosity of pervious concrete, sprinkling baking soda over a slab of pervious concrete will cause the baking soda to penetrate into the pores of the concrete, thus requiring the user to employ a significantly greater quantity of the baking soda and much more effort to brush the baking soda into the concrete to complete the neutralization process when compared to the neutralization on impervious concrete. This results in additional neutralizer material costs and additional labor costs.

However, one of the most troublesome difficulties in acid dye staining pervious concrete results from the use of the sealer. As stated above, the final step in acid-dye coloring concrete is to apply a sealer, which usually comprises an acrylic sealer. The sealer is necessary to prevent premature degradation of the concrete. Most acrylic sealers cannot be used with pervious concrete because such acrylic and other oil-based sealers form a film over the concrete, thereby clogging the “pores” of the concrete. This film functionally converts the pervious concrete into impervious concrete, because the film prevents the passage of functionally significant quantities of water through the concrete slab. Additionally, the acrylic sealer that flows through the pores and voids in the pervious concrete will tend to clog the pores and voids to further aid in the conversion of the pervious concrete into functionally impervious concrete.

Fortunately, sealers exist today that do permit pervious concrete to be sealed. One such sealer is a soybean-based sealer sold under the trademark THE BEAN® by C2 Products, Inc. of Cicero, Ind. Unlike acrylic or other water-based sealers, THE BEAN® sealer can coat the surface of the pervious concrete without blocking the pores and voids. Additionally, since THE BEAN® brand sealer is made from a natural product (soybean oil), the passage of the soybean oil through the pervious concrete does not create an environmental hazzard, as the soybean oil can break down within the ground, as would any natural vegetable-based oil.

One object of the present invention is to provide a method and product for facilitating easy dying and staining and thereby coloration of pervious concrete, which does not cause the pores and voids within the pervious concrete to be blocked, thereby not impairing the functionality of the pervious concrete.

### IV. SUMMARY OF THE INVENTION

In accordance with the present invention. A colorizing composition for adding color to a concrete structure comprises a color additive containing a pigment component, a vegetable oil based diluent, and a vegetable oil based sealer component. The combined sealer and color additive, when applied to a pervious concrete, will permit the flow of water through the pervious concrete.

Preferably, this porosity is achieved without reducing or inhibiting the ability of the sealer to provide a good seal that protects the concrete.

Preferably, the pigment component is selected from the group consisting of organic pigments and inorganic pigments. More preferably, the pigment component comprises an inorganic metal oxide pigment; and most preferably, the pigment component comprises an inorganic metal oxide pigment slurry.

Examples of such a metal oxide-based pigment are the COLOR FLO® brand pigments sold by Prism Pigments of St. Paul, Minn. and Solomon Colors of Springfield, Ill. An appropriate amount of the colorant is added to a soybean-based oil, such as THE BEAN®. This soybean-based oil and pigment mix is mixed in a quantity and at a ratio designed to achieve the appropriate color intensity desired by the user.

The pigment/plant oil mix is then mixed into a sealer that also comprises a soybean-based oil, such as THE BEAN® brand soybean oil to form the final pigment-sealer admixture. The pigment-sealer admixture can then be applied to the surface of the pervious concrete. When so applied, the pervious concrete will be both pigmented to a desired color, and sealed with a protective coating.

Also in accordance with present invention, a method is provided for colorizing and sealing a void-containing pervious concrete structure. The method comprises: preparing a color additive mixture that includes a pigment component and a vegetable oil based diluent component. The color additive mixture is added to a vegetable oil based sealer component to form a color additive sealer mixture. The color additive sealer mixture is applied to a pervious concrete structure; and the applied color additive sealer mixture is permitted to penetrate voids in the pervious concrete while still permitting the flow of water through the voids.

Preferably, the pigment component and diluent are combined in an appropriate proportion to obtain the color desired by the user, and to thereby form a finalized “pigment packet.” which is separately packaged for distribution separate from the sealer.

The Pigment containing colorant additive package pigment packet is then added to an appropriate amount of soybean oil-based sealer, such as THE BEAN® sealer, to form the pigment containing sealer.

Preferably, the pigment-containing sealer is then applied in appropriate concentrations to the surface of the pervious concrete structure to be treated. The pigment-sealer mix can be applied with a pressure sprayer, spray gun, roller, paint brush or any other typical paint-type applicator. The pressure sprayer can comprise a garden type pressure sprayer or commercial type pressure sprayer.

### V. DETAILED DESCRIPTION OF THE PREFERRED EMBODIMENT

A. Pervious Concrete.

Prior to the discussion of the components of the colorizer-sealer of the present invention, it is helpful to review the properties of pervious concrete, to help describe the characteristics of pervious concrete and to help point out differences between pervious concrete and traditional impervious concrete.

In pervious concrete, carefully controlled amounts of water and cementitious materials are used to create a paste that forms a thick coating around aggregate particles. A pervious concrete mixture contains little or no sand, creating a substantial void content. Using sufficient paste to coat and bind the aggregate particles together creates a system of highly permeable, interconnected voids (pores) that drains quickly. Typically, between 15% and 25% voids are achieved in the hardened pervious concrete. Flow rates for water through pervious concrete are typically around 480 in./hr (0.34 cm/s, which is 5 gal/ft²/min or 200 L/m²/min), although they can be much higher. Both the low mortar content and high porosity also reduce strength compared to conventional, impervious concrete mixtures. However, sufficient strength for many applications is readily achieved.

While pervious concrete can be used for a surprising number of applications, its primary use is in pavement. Pervious concrete also at times has been referred to as porous concrete, permeable concrete, no-fines concrete, gap-graded concrete, and enhanced-porosity concrete.

I. Properties of Pervious Concrete

(a) Density and Porosity

The density of pervious concrete depends on the properties and proportions of the materials used, and on the compaction procedures used in placement. In-place densities on the order of 100 lb/ft³to 125 lb/ft³ (1600 kg/m³ to 2000 kg/m³) are common, which is in the upper range of lightweight concretes. A pavement 5 inches (125 mm) thick with 20% voids will be able to store 1 inch (25 mm) of a sustained rainstorm in its voids. This volume is sufficient to handle the vast majority of rainfall events in the U.S. When a 5 inch layer of this pervious concrete is placed on a 6 inch (150-mm) thick layer of open-graded gravel or crushed rock sub-base (underlayment), the storage capacity increases to as much as 3 inches (75 mm) of precipitation.

(b) Permeability

The flow rate through pervious concrete depends on the materials and placing operations. Typical flow rates for water through pervious concrete are 3 gal/ft²/min (288 in./hr, 120 L/m²/min, or 0.2 cm/s) to 8 gal/ft²/min (770 in./hr, 320 L/m²/min, or 0.54 cm/s), with rates of up to 17 gal/ft²/min (1650 in./hr, 700 L/m²/min, 1.2 cm/s). Even higher rates have been measured in the laboratory.

(c) Compressive Strength

Pervious concrete mixtures can develop compressive strengths in the range of 500 to 4000 psi (3.5 MPa to 28 MPa), which is suitable for a wide range of applications. Typical values are about 2500 psi (17 MPa). As with any concrete, the properties and combinations of specific materials, as well as placement techniques and environmental conditions, will dictate the actual in-place strength.

(d) Flexural Strength

Flexural strength in pervious concretes generally ranges between about 150 psi (1 MPa) and 550 psi (3.8 MPa). Many factors influence the flexural strength, particularly the degree of compaction, the porosity, and the aggregate-to-cement (A/C) ratio. However, the typical application constructed with pervious concrete does not require the measurement of flexural strength for design.

(e) Shrinkage

Drying shrinkage of pervious concrete develops sooner, but is much less than conventional concrete. Specific values will depend on the mixtures and materials used, but values on the order of 0.002 have been reported, roughly half that of conventional impervious concrete mixtures. Roughly 50% to 80% of shrinkage occurs in the first 10 days, compared to 20% to 30% in the same period for conventional concrete. Because of this lower shrinkage and the surface texture, many pervious concretes are made without control joints and are allowed to crack randomly

B. The Components

There are three primary components of the colorizing sealer mixture of the present invention. These three components include (1) the pigment; (2) the diluent that is added to the pigment to form the pigment/diluent mix; and (3) the sealer.

1. The Pigment Material

The pigment material is preferably a pigment material that is designed for use as a concrete colorant.

There are two primary classes of colorants: organic colorants, and in-organic colorants. Colorants that are designed especially for use in coloring concrete are produced by a wide variety of manufacturers. These manufacturers include such companies as Solomon Colors, 4050 Color Plant Road, Springfield, Ill. 62702; Prism Pigments, a division of Mix Manufacturing, Inc., 1251 Arundel Street, St. Paul, Minn. 55157; Concrete Chemicals, 725 Warrington Avenue, Redwood City, Calif. 94063; and Davis Colors, 3700 East Olympic Boulevard, Los Angeles, Calif.

Organic pigments have the ability to produce very vibrant blues and greens, especially in white cement. As such, they are often desirable for use in swimming pool environments. Organic pigments are often less expensive, and very easy to use when compared to inorganic pigments. However, organic pigments have a drawback, as many organic pigments known today tend to be less durable, and more subject to fading than currently known inorganic pigments. Additionally, a carbon black can be used as a main component of an organic pigment. Liquid black is very useful in achieving gray tones.

Inorganic pigments are also capable of producing a rainbow of colors including blues, greens, tans, reds, yellows, grays and aquas. Inorganic pigments tend to be more durable than organic pigments, and, at present, appear to generally be capable of resisting fading in the presence of UV light, and chemical abuse, such as that which occurs by chlorination in pool environments. Inorganic pigments are especially useful when one is doing a coloration job that is meant to last a lifetime, and when the particular concrete slab being colored is being placed outdoors in a bright sunlight.

Most inorganic pigments comprise a metal oxide material. Metal oxides include such things as iron oxides, titanium oxides (used primarily in white), and magnesium oxides.

Of these various oxides, the most popular are iron oxides. Many of these oxides are synthetic iron oxides. For example, Prism Pigments states that its concrete colors contain only finely milled synthetic iron oxides, which it believes to be strongest and most stable colors available. Prism states that its synthetic iron oxide colors are lime proof, sun fast, inert, and meet or exceed the criteria of ASTM C979.

Inorganic colorants are also available in a wide array of colors. For example, Prism Pigments advertises that their colors cover the full range of the color spectrum, including brown, buff, tan, black, yellow, orange, red, green, blue and white.

Inorganic pigments (and organic pigments) are similar to paints, as the number of colors that is theoretically available is almost limitless. Various pigments can be mixed together to achieve different colors, in much the same way that various “tints” used in paint can be mixed together to form an almost endless variety of paint colors.

Pigments are generally available as both a dry powder, and also as slurries. It has been found by Applicant that the preferred type of pigment to use is a slurry type pigment. Liquid pigments work well because they tend to provide consistently accurate colors, and mix rapidly to produce uniform and consistent colors. Additionally, liquid pigments have the ability to stay in suspension to achieve full color development in the mix.

Solomon Pigments produces a liquid iron oxide pigment under its COLOR FLO® brand colorants. The COLOR FLO® pigments comprise liquid iron oxide pigments that comprise an iron oxide slurry. Such slurries comprise high solid dispersions of iron oxide pigments in water, with total pigment levels of between 60% and 70%.

COLOR FLO® liquid pigments are advertised by Solomon Colors to utilize pure red, yellow and black synthetic iron oxides. Each of the colors provided by Solomon is generally 95% to 99%, minus 325 mesh particle size. The colors produced with these liquid iron oxide pigment slurries are advertised by Solomon to be permanent, inert, stable to atmospheric conditions, sun fast, lime proof and free of deleterious fillers and extenders. The Solomon liquid slurry pigments are also advertised to comply with ASTM C979 for integrally colored concrete, and are produced to 0.8 Delta E, an established plant standard.

2. The Diluent

The pigment described above is mixed with diluent to form a color additive mixture. Preferably, the diluent employed comprises a soya oil such as THE BEAN® brand soya oil that is distributed by C2 Products of Cicero, Ind. The BEAN® soya oil can be produced generally according to the teachings of Lightcap, Jr., U.S. Pat. No. 5,647,899. Lightcap, U.S. Pat. No. 5,647,899 is fully incorporated herein by reference.

Lightcap '899 describes his material as a water dispersible sealing composition for protecting concrete against spilling, cracking and other deterioration caused by the penetration of water through exposed concrete surfaces. The sealing composition preferably comprises an oil-in-water emulsion prepared from a pre-emulsion concentrate having a high concentration of a non-refined vegetable oil. Preferably, the non-refined vegetable oil comprises soya oil, although other non-refined suitable vegetable oils can be used that include such things as coconut oil, corn oil, cottonseed oil, palm oil, canola oil, and sunflower oil.

The term “non-refined” is generally used in the vegetable oil industry to refer to oil that is pressed from soy bean flakes by a mechanical means, or extracted from soy bean flakes with mixed hexanes. The solvent is then removed to produce the initial “crude oil”. This “unrefined” soy bean oil can be converted into refined soy bean oil by the removal of the fatty acids and other non-oil materials by chemical means and physical and/or mechanical separation.

A typical composition for an unrefined soybean oil is set forth below in Table I, which is taken from Lightcap, U.S. Pat. No. 5,647,899.

TABLE I

| | Non-refined | Refined |
|---|---|---|
| Triglcerides | 95-97 | >99 |
| Phosphatides | 1.5-2.5 | 0.003-0.005 |
| Unsaponifiable matter | 1.6 | 0.3 |
| Plant sterols | 0.33 | 0.13 |
| Tocopherols | 0.15-0.21 | 0.11-0.18 |
| Hydrocarbons (Squalene) | 0.014 | 0.01 |
| Free fatty acids | 0.3-0.7 | <0.05 |
| Trace metals | | |
| Iron, ppm | 1-3 | 0.1-0.3 |
| Copper, ppm | 0.03-0.05 | 0.02-0.06 |

A pre-emulsion concentrate is prepared by using an emulsifier which is suitable for providing a stable oil and emulsifier composition having a large percentage of non-refined vegetable oil.

According to Lightcap, alkyl, aryl or glycol ethoxylate, propoxylate, butoxylate or sulfonate based emulsifiers may be used in the present invention to facilitate the formation of the non-refined vegetable oil pre-emulsion concentrate.

The BEAN® oil preferably is prepared by mixing about 70%-90% by weight of a non-refined vegetable oil with about 5% to 30% by weight of an emulsifier to form a stable pre-emulsion concentrate. The emulsifier most preferably comprises a three mole ethylene oxide adduct of C12 and C14 alcohols. The pre-emulsion concentrate may be stored until ready to use or shipped to the ultimate consumer for use.

The pre-emulsion concentrate is mixed with water to form the sealing composition having the desired viscosity. The viscosity should be low enough to ensure that the composition can be easily dispensed by using conventional brush roller spray systems and to allow penetration of the composition into the pores of the concrete.

In a most preferred embodiment of the diluent, the pre-emulsion concentrate comprises about 88% of a non-refined soybean oil and about 11% by weight of an emulsifier comprising a 3 mole ethylene oxide adduct of C12 and C14 alcohols. The oil and emulsifier are intimately blended together at about 70-100 degrees F. to form the pre-emulsion concentrate. To produce the desired sealing composition for concrete, the pre-emulsion concentrate is added to water such that the ratio by volume of water to the pre-emulsion concentrate is about 2 to 1.

To produce the initial color additive package, the soybean oil based diluent (described above), and most preferably, THE BEAN® brand soybean based oil base sealant is mixed in equal proportions with the colorant (pigment). Although most mixes would generally be at a 50-50 level, other mixture levels may also be used, depending upon the particular color desired and the strength of the end color desired. Generally, the mixture will be in the range of between about 40% colorant to about 60% colorant; and between about 60% diluent to 40% diluent.

One of the difficulties encountered when trying to obtain a desired color of concrete is to match the colorant material in a manner so that when the colorant is added to the diluent, and when the color additive package is added to the sealant, the color additive package will have the appropriate color to cause the pervious concrete to be dyed the appropriate color. The term “color additive package” is used in this application to denote the mixture of pigment and diluent described above. As discussed below, this color additive package is added to the sealant to form the colorant-sealant of the present invention.

Surprisingly, the Applicant has found that this process can be simplified greatly by varying the diluent and colorant percentages within the colorant additive package to produce a standardized color additive package. In other words, achieving different colors may require different mixtures (both qualitatively and quantitatively) of diluent and colorant. By selecting the appropriate ratios and types of diluent and colorant, the standardized color additive package can be produced. For example, in the most preferred color additive package, the total amount of diluent and colorant (by volume) equates to approximately 50 oz., which can then be packaged preferably in a 50 oz. plastic container. This 50 oz. package of color additive is then chosen to be the standardized amount which, when mixed with 5 gallons of sealant, will permit the user to achieve the desired color in the final colorized sealer, and in the colorized concrete produced through the application of the colorized sealant thereto. By enabling the color additive and sealer to always be mixed in the same ratio, the task of appropriately mixing the colors is made much easier for the end user, concrete pouring/coloring company.

The packages in which the color additive is packaged are preferably of a standardized size. The size should be chosen so that color additive packages can be added in whole number quantities to the sealant to achieve the proper color additive/sealant ratio to achieve the desired color.

Typically, sealant is sold in 5-gallon containers. For such 5-gallon containers, Applicant has found that the color additive package should be packaged in a 50 oz. container, that, as discussed above, would normally comprise somewhere between 20 and 30 ounces of colorant, and 20 and 30 ounces of diluent, and in the preferred case, approximately 25 oz of each of the colorant and the diluent. The 50 oz. color additive package is formulated so that one color additive package will be added to one 5-gallon container of sealant to produce a 5-gallon, 50 oz “batch” of colorized sealant.

As such, when so mixed, the color additive (50 oz) when added to a 5-gallon container (640 oz), will make a 690 oz batch of colorized sealant. As such, in the final mixture, the color additive will generally comprise about 7.25% of the final colorant-sealant mixture.

As discussed above, the colorant portion of the color additive comprises generally somewhere 40 and 60% of the color additive mixture. Therefore, the colorant will comprise generally between about 2.9% and 4.3% (approximately) of the final colorant-sealant mixture. As the preferred ratio of the colorant to diluent in the color additive package is about 50-50, the normal percentage of colorant in the color additive-sealant mixture will be approximately 3.6%.

The general ratio of the color additive package (diluent plus colorant) mixture comprising approximately 0.725% by volume of the final sealant-colorant mixture will generally remain constant, regardless of the packaging size in which the color additive package is sold. Although the color additive package has been discussed above as being a 50 oz. color additive package for use with a 5-gallon container, it will be appreciated that a 10 oz color package would be useful with a 1-gallon container.

Although fractional packages could be used, it is the Applicant's belief that the present invention will benefit if the invention is easy to use, and that this ease of use is facilitated by sizing the color additive packages so that a “whole number” of color additive packages can be used in connection with the desired quantity of sealant. This “whole number” sizing helps to enable the end user to add the appropriate whole number of color additive packages to the sealer batch to create a sealant that will have the appropriate color. As such, if the final user is mixing up a color additive package with a 10-gallon quantity of sealer, the end user would employ two, 50 oz packages of color additive that would then be added to the sealer, to create an appropriate color.

In current industry practices, 5-gallon containers tend to be the normal quantity in which the sealer is packaged. 5-gallon quantities work well because they provide enough sealer to do a large surface area, without creating a package that is too heavy to be easily transported. Additionally, there exists a plurality of manufacturers who produce 5-gallon tubs that are suitable for packaging sealer, thus saving the manufacturer the need to create custom designed and custom sized tubs.

One characteristic that the present invention tries to achieve is the ability to enable the user to create uniform colors from batch to batch of color additive-sealer mix.

In many cases, the size of the concrete slab being sealed will require that several (e.g. 5 or 6) 5-gallon containers of sealant be employed. As the preferred size with which to deal with the sealant is a 5-gallon size, this will require the user to make up 5 batches of colorized sealant.

As it is desirable that the color produced on the concrete slab be identical for all five batches, it is most helpful to the end user if a means exists to enable him to mix all 5 batches in a manner that will enable him to achieve this uniformity.

To facilitate this color matching between batches, the Applicant has found that the whole number color additive package mixing scheme facilitates this color matching process by enabling the end user to add one whole number package to each 5-gallon container of sealant, without forcing the user to measure any quantities, as the quantities are already pre-measured.

Although achieving an exact match between different batches is often a real-world impossibility, the packaging system invented by Applicant does help to ensure that the end user can match the colors in various batches closely enough to achieve satisfactory results, with only a minimal amount of effort being required to achieve such uniformity.

Additionally, it will also be appreciated that the composition of the present invention can be sold as a pre-packaged mixture, wherein the color additive is already added to the sealer. This type of packaging may have a special appeal in the retail market where retail customers are unfamiliar with mixing colors with sealant.

In such a case, the composition of the present invention would likely be packaged similarly to paint. That is, the retail establishment would purchase large quantities of uncolored sealant. The uncolored sealant would not add additional inventory items to the store, as the uncolored sealant has great utility, even without the colorant, as a sealer for concrete driveways, decks and the like in situations where the user does not desire to impart any additional color.

The retail establishment would then mix in the color additive in appropriate quantities to create the desired color, in much the same way that retail establishments currently mix various tints into a white “base” paint to create paints of different colors. Due to the very large variety of colors that are available through appropriate mixing, it is believed, presently, that selling pre-mixed containers of sealant wherein the color additive was already added prior to its shipment to the retail establishment would be technologically feasible, but generally economically undesirable, as it would require the retailer to maintain an undesirably large number of colors in inventory, thereby requiring an undesirably large amount of shelf space to hold the inventory. Additionally, the large inventory would deleteriously impact the retailer's floor-planning costs.

It will be appreciated that these figures and percentages are based largely upon the use of the particular colorants employed by Applicant currently. More diluted colorants, or more concentrated colorants would likely alter the percentages given herein. It should further be noted that a likelihood exists that certain particular desired colors may require either an excess amount of colorant in order to be achieved, or a particularly low amount of colorant in order to be achieved, and as such, could fall out of these ranges.

3. The Sealant

The preferred sealant that is used in connection with the present invention comprises a non-refined vegetable oil, that is preferably soya (soybean) oil, that essentially comprises about 95% to about 50% by weight of a non-refined vegetable oil, about 5% to about 50% of an emulsifier comprising a 3 mole ethylene oxide adduct of C12 and C14 alcohols; and water. As such, THE BEAN® soybean-based sealant described above, and in Lightcap, U.S. Pat. No. 5,647,899, is the preferred sealant of choice.

This soybean-based sealant is preferred for a variety of reasons. One reason relates to its environmental friendliness. As the sealant comprises primarily a soybean based sealant, the sealant is both biodegradable, and generally non-toxic to the environment. Additionally, the particular viscosity characteristics achievable with this oil, permit it to flow through and coat the pores of the pervious concrete without blocking the pores (voids) to the further flow of water therethrough. As discussed above, one of the difficulties of using traditional acrylic-based sealants with pervious concrete, is that such sealants form a film over the concrete. This film penetrates into the voids and pores of the pervious concrete, and clogs these pores and voids. Once these pores and voids are clogged, the pervious concrete in effect turns into an impervious concrete, because the pervious concrete will not allow water to flow there through. At that point, the advantages that one obtains with the use of pervious concrete are lost.

In particular, the ability of pervious concrete to allow water to pass there through, to thereby eliminate the need to separately deal with run off is lost. The water that impacts the concrete, primarily in the form of rain water, cannot pass through the concrete. Rather, the water then runs along the concrete and either pools up on the concrete, or runs off the side or edge of the concrete or into drains and becomes run-off that must be handled by a retention pond source system or the like.

Additionally, the sealer discussed above, when mixed with a sealant additive cannot only add decorative beauty to the concrete, but also will be long lasting. The sealer will further help to protect the surface of the concrete to prevent degradation of the surface of the concrete, to thereby enable the concrete to last for a longer period time and increase its useful life.

B. Preparing the Composition

The first step in creating the pigmented sealer of the present invention is to employ a suitable pigment or colorant. It has been found by the Applicant that a suitable pigment for use with the present invention are the pigments discussed above.

Once one has a pigment of a certain color, such as the red #417 pigment sold by Solomon Colors, one then has the ability to vary the hue or the intensity of the pigment by the choice of how the dye (pigment) is mixed with a diluent to form the color additive package.

As discussed above, the preferred diluent is a plant-based oil, and preferably, a soybean oil, and most preferably, a soybean oil such as THE BEAN® soybean oil. The amount of the diluent that is added to the Solomon Colors pigment will vary depending upon the intensity. The more diluent one adds, the less intense the color is or the lighter hue the color becomes. For example, the #417 Solomon Color Flo pigment and can be diluted by only a small percent of diluent, such that final pigment-sealer admixture comprises four percent of colorant, to form a very intense Apple Red. By increasing the relative percentage diluent so that the final percentage of the pigment component is 1% in the final sealer-pigment admixture, one can get a much lighter, less intense “rose” color. The general notion of diluent ratios will be understood by those skilled in the art upon reviewing this application.

The first step is to take a suitable amount of pigment, and mix it with a suitable amount of THE BEAN® brand oil diluent to form a final pigment mixture. Assume for the present, that a ratio of 50% pigment to 50% bean oil is used to achieve a certain dye color. If one uses the #417 color, this 50/50 mixture will form a color denoted by Solomon Colors as a “brick red”. For example, 5 oz. of pigment added to 5 oz. of soybean oil would yield a 10 ounce brick red dye (pigment) color additive packet.

The second step in the process is to add the pigment-diluent mix to an appropriate amount of sealer.

It has been found by the Applicants, that the most convenient way to enable the user to get a uniform, desirable color, is to make the pigment-diluent mixes in advance and to place them in a standard size container to form a “color additive package”, such as a 10 oz. container color additive package containing the mixed pigment and diluent. The user can then be instructed to add the 10 oz. Color additive package to a given volume of sealer (e.g. one gallon), which then forms preferably a pigmented sealer composition of about 138 oz, which is composed of 10 oz. pigment/diluent mix color additive and one gallon (128 oz.) of sealer. Similarly, if the user wanted a “rose” colored concrete slab, the manufacture might employ seven ounces of diluent and three ounces of #417 Solomon COLOR FLO color pigment to form a 10 oz. color additive package of diluted pigment. The addition of this ten ounces of diluted pigment to one gallon of sealer would then yield a rose colored pigmented sealer capable of imparting a rose color to an area of about 250 square ft. of a slab of pervious concrete.

By keeping the container size of the color additive package uniform, and the color additive/sealant mixture proportions uniform, it is very easy for the user in the field to obtain the correct mixture without having to calculate percentages and the like, since preferably, the diluted pigment is formulated so that a similiar amount of diluted pigment is employed on a volume to volume basis, regardless of the desired end color.

As such, the pigment-diluent package should be done preferably at the manufacturer's location or at a lab close to the site where the mixture can be mixed, and then packaged at a packaging facility where it can be packaged. In a consumer-retail, or other low volume application, this mixing can be done at a paint-store type retail establishment such as Sherwin-Williams® or Home Depot®.

At the packaging plant, the color additive mix should be packaged into appropriate containers. In the instant case, for example, the diluted pigment color additive mix can be packaged in 10 oz. containers, which the Applicant has found to be an appropriate amount for use in connection with 1 gallon of sealer. It also will be appreciated that larger, or smaller quantities can be mixed, depending upon the sealer volume. For example, 50 oz. packets of dye-diluent can be mixed that would work well in a five gallon container of sealer to form a 5 gallon, 50 oz. (178 oz) batch of colorized sealer. It is believed by the Applicant that the 50 oz. color additive package will likely be the most popular size in view of the typical sizes of the concrete slabs that are expected to be longer than the 1250 square feet that can generally be covered by a 5 gallon, 50 oz. color additive package-sealant mix.

Once the colorized sealer is mixed to an appropriate level, the next step in the process is to apply the pigment-containing sealer to the concrete slab. Because of the nature of THE BEAN® oil, which serves as the primary sealer, much effort is saved during this application. There is no need to apply an acid to the concrete slab prior to sealing/colorizing. Nor is there generally any need to neutralize the acid and to wash off the acid from the slab. Rather, the colorant containing sealer can usually be applied directly to the slab with a sprayer mechanism. On smaller scale slabs, such as driveways or decks, this sealer can be applied through the use of a sprayer, such as a pressure sprayer or garden sprayer. On larger jobs, such as parking lots, it may be applied by a truck-borne tank to which is coupled a compressor for pressurizing and spraying the sealer through an application wand similar to an application wand that one may find connected to a pressure washer; or to a plurality of truck-mounted pressure wands/nozzles.

The typical application rate for the pigment-containing THE BEAN® oil sealer is at a rate of approximately 1 gallon for every 250 square feet of pervious concrete slab area. However, it will be appreciated that this coverage rate can vary.

It has been found by the Applicant that one of the more important factors that will determine the amount of variance is the finish surface of a particular concrete slab. For example, when the pigmented sealer of the present invention is used in connection with an impervious concrete having a “hard trowed” finish (such as one might find inside one's garage or basement floor), the coverage rate may be 1 gallon for every 500 square feet of slab area due to the fact that impervious concrete will not “soak up” as much of THE BEAN® brand oil sealer since the impervious concrete does not contain the large amount of pores necessary to soak it up. However, on pervious concrete which has pores and voids into which the sealer can flow, the coverage rate may be less, and closer to 250 square feet of coverage per gallon of THE BEAN® brand oil sealant applied.

One advantageous feature of the pigmented sealer oil of the present invention is that it can be applied in multiple coats to a slab of concrete to achieve the desired color. For example, if one applies the #417 based color dye to a slab of concrete, and winds up with a color that is a light red color, such as a rose-colored red, one can darken the color by applying a second coat of the pigmented sealer to achieve a deeper, more intense hue type color such as the brick red. Through this process, the user is provided with a significant advantage of having the capacity for achieving “forgiveness” for a first coat that is not the user's desired color.

An important thing to note about coloring concrete to achieve a color is that a pigment should not be applied by itself without a sealer. If one applies just the pigment to a concrete slab, the color will not hold, but typically will wear off in a short time period. As such, a sealer is needed in connection with the pigment to hold the pigment onto the surface of the concrete, and thereby to hold the “color” onto the concrete.

It should further be noted that one of the benefits of the current invention is that the pigment and the sealer coat are applied simultaneously in one process, and in one coat. By contrast, with the acid stain process described above, you have at least a three stage process.

The first step is mixing the acid and the stain together and applying it to the driveway or slab. The second step is neutralizing the acid with a neutralizer such as baking soda. The third step is applying the sealer over the surface of the concrete to hold the stain into the concrete.

In the current invention, this three step process is reduced to a one-step process, since one applies the stain and sealer in one step without the requirement of both applying and neutralizing an acid As such, the present invention is much less labor intensive because of the one-step nature of the instant process versus the three step nature of the prior art.

Although the presently perceived preferred embodiments of the invention have been set forth above, it will be apparent to those skilled in the art that various changes and modifications may be made without departing from the spirit and scope of the invention as set forth in the following claims.

What is claimed:

1. A colorizing composition for adding color to a concrete structure comprising
a color additive containing a pigment component and a vegetable oil based diluent, and
a vegetable oil based sealer component,
wherein the combined sealer and color additive, when applied to a pervious concrete, will permit the flow of water through the pervious concrete.

2. The composition of claim 1 wherein the pigment component is selected from the group consisting of organic pigments and inorganic pigments.

3. The composition of claim 1 wherein the pigment component comprises an inorganic metal oxide pigment.

4. The composition of claim 3 wherein the pigment component comprises an inorganic metal oxide pigment slurry.

5. The composition of claim 1 wherein the vegetable oil based diluent comprises a soybean oil based diluent.

6. The composition of claim 5 wherein the soybean oil based diluent comprises an emulsifier containing soybean oil based diluent.

7. The composition of claim 6 wherein the emulsifier based diluent includes an emulsifier comprising a 3 mole ethylene oxide adduct of C12 and C14 alcohols.

8. The composition of claim 6 wherein the vegetable oil based sealer compound comprises a soybean oil based sealer which includes an emulsifier and water.

9. The composition of claim 6 wherein the color additive includes, by volume, between about 40% and 60% pigment component and between about 40% and 60% soybean oil based diluent.

10. The composition of claim 6 wherein the color additive includes, by volume, a generally equal amount of the pigment component and the soybean based diluent.

11. The composition of claim 6 wherein the pigment compound comprises between about 2.9% and 4.4% of the final color additive and sealant mix composition.

12. The composition of claim 6 wherein the pigment component comprises a metal oxide pigment component.

13. The composition of claim 1 wherein the vegetable oil based sealer comprises a soybean oil based sealer.

14. The composition of claim 13 where the soybean oil based sealer comprises a soybean oil based sealer to which an emulsifier and water have been added.

15. A method for colorizing and sealing a void-containing pervious concrete structure comprising:
(a) preparing a color additive mixture that includes a pigment component and a vegetable oil based diluent component,
(b) adding the color additive mixture to a vegetable oil based sealer component to form a color additive sealer mixture,
(c) applying the color additive sealer mixture to a pervious concrete structure, and
(d) permitting the applied color additive sealer mixture to penetrate voids in the pervious concrete while still permitting the flow of water through the voids.

16. The method of claim 16 wherein the step of permitting the applied color additive-sealer mixture to penetrate voids in the pervious concrete while still permitting the flow of water through the voids includes the step of permitting the flow of water through the voids at a rate greater than one gallon per minute per square foot of surface area of the pervious concrete structure.

17. The method of claim 16 wherein the step of permitting the applied color additive-sealer mixture to penetrate voids in the pervious concrete while still permitting the flow of water through the voids includes the step of permitting the flow of water through the voids at a rate greater than about 2.5 gallons per minute per square foot of surface area of the pervious concrete structure.

18. A color additive package capable of being added to a vegetable oil based sealer to form colorized sealer capable of being applied to pervious concrete in a manner that will permit the flow of water through the pervious concrete, the color additive comprising a pigment component and a vegetable oil based diluent.

19. The color additive package of claim 18 wherein the color additive package includes the proper quantity of color additive so that the entire content of the package can appropriately colorize a standardized container of sealer.

20. The color additive package of claim 19 wherein the quantity of the color additive package is chosen from the group consisting of 10 oz. and 50 oz.
